(19) United States
(12) Patent Application Publication
(10) Pub. No.: US 2012/0073470 A1
(43) Pub. Date: Mar. 29, 2012

(54) PAINT HARDENER

(75) Inventors: Christopher Henry Such, Victoria, (AU); Thamala Chandrakanthi Weerasinghe, Burwood East (AU); Rodney Alan Vockler, Victoria (AU)

(73) Assignee: duxgroup (Australia) Pty Ltd., Clayton, Victoria (AU)

(21) Appl. No.: 13/375,445

(22) PCT Filed: Jun. 8, 2010
(86) PCT No.: PCT/AU2010/000705

§ 371 Date: Nov. 30, 2011

Related U.S. Application Data
(60) Provisional application No. 61/185,456, filed on Jun. 9, 2009.
(60) Provisional application No. 61/234,135, filed on Aug. 14, 2009.

(51) Int. Cl. C09D 189/00; C08L 89/00

(52) U.S. Cl. 106/160.1; 106/501.1

(57) ABSTRACT

Compositions for hardening paint, particularly residual waste water-based paints are described. The compositions comprise at least one water soluble or water dispersible, natural or synthetic polymer and optionally an agent that increases the ionic strength of the paint. Methods of hardening waste water-based paint for environmentally responsible disposal are also described.

### FIELD OF THE INVENTION

The present invention relates to a composition for hardening paint, especially residual waste water-based paint. The invention also relates to methods of hardening water-based paint for environmentally responsible disposal.

### BACKGROUND OF THE INVENTION

Disposal of residual or left-over water-based paint is a significant problem for individual consumers and those working in the painting industry such as users of paint products and manufacturers of paint products. Residual paint may be classed as hazardous waste and incorrect disposal of paint can cause environmental damage.

Disposal of residual paints may be a service provided by some waste-disposal organisations if all liquid is removed first. However, drying of paint may take a long time and often drying paint forms a skin that prevents further drying of paint under the skin. Furthermore, many paint cans containing residual paint may accumulate during the drying process.

Individual consumers often do not know how to easily dispose of their residual paint resulting in the accumulation of paint cans with varying amounts of paint in backyards, sheds or storage places in many households.

There are some paint hardening products commercially available that raise the ionic strength of the paint resulting in hardening of the paint. However, these paint hardening products do not harden the full range of water-based paints available on the market. In particular, these products do not harden paints that contain high levels of non-ionic surfactant.

Other commercially available products that harden water-based paint include superabsorbent products. These products work over the full range of water-based paints. However, with these products, some paint residues may be leached from the hardened paint when it is subsequently exposed to water. This can cause an environmental hazard and decrease the safety of disposing of this type of hardened paint.

There is a need for paint hardening compositions that are able to harden a wide range of paints, including paints stabilized by high levels of non-ionic surfactant, and may also provide a hardened paint product that is stable to exposure to water.

### SUMMARY OF THE INVENTION

The present invention provides compositions for hardening water-based paint and methods to facilitate disposal of waste paint in an environmentally responsible manner.

According to one aspect of the present invention, there is provided a composition for hardening water-based paint comprising:
(i) an agent that increases the ionic strength of water-based paint to be hardened; and
(ii) at least one water soluble or water dispersible, natural or synthetic polymer.

In some embodiments, the agent that increases the ionic strength of the water-based paint to be hardened comprises at least one aluminium compound, especially a combination of polyaluminium chloride and aluminium sulphate. In some embodiments, the polymer is a natural polyamide polymer, especially gelatine, Pea Protein Isolate, Agar-Agar and Soya Protein, more especially gelatine.

According to another aspect of the invention there is provided a method of hardening water-based paint comprising the steps of:
(i) providing waste water-based paint;
(ii) adding a composition comprising:
   (a) an agent that increases the ionic strength of the paint; and
   (b) at least one water soluble or water dispersible, natural or synthetic polymer; and
(iii) mixing the water-based paint and the composition and allowing the resulting paint composition to harden.

In yet another aspect of the invention, there is provided a method of hardening water-based paint comprising the steps of:
(i) providing water-based paint;
(ii) adding at least one water soluble or water dispersible, natural or synthetic polymer;
(iii) mixing the water-based paint and the polymer and allowing the resulting paint composition to harden.

In some embodiments of the above methods, the waste paint is water-based paint stabilized by non-ionic surfactant.

According to another aspect of the present invention, there is provided hardened water-based paint formed in accordance with the foregoing methods.

In yet another aspect of the invention there is provided a method of disposing of residual waste water-based paint comprising the steps of:
(i) hardening residual water-based paint with a composition comprising:
   (a) an agent that increases the ionic strength of the paint; and
   (b) at least one water soluble or water dispersible, natural or synthetic polymer; and
(ii) disposing of the hardened residual water-based paint.

In a further aspect of the invention, there is provided a method of disposing of residual waste water-based paint comprising the steps of:
(i) hardening residual waste water-based paint with at least one water soluble or water dispersible, natural or synthetic polymer; and
(ii) disposing of the hardened residual water-based paint.

### DESCRIPTION OF THE INVENTION

The present invention provides a composition suitable for hardening residual waste water-based paint, especially undiluted paint left over in paint cans or containers.

The paint may be any water-based paint including decorative architectural paints over a full range of gloss to flat wall paints, undercoats and top coats; industrial coatings and water-based wood stains.

The paint may also be a paint that has been stabilized by high levels of non-ionic surfactant. The term “high levels of non-ionic surfactant” refers to an amount of non-ionic surfactant that prevents paint hardening when the paint is treated with an agent that increases the ionic strength of the paint. The non-ionic surfactant has an HLB sufficient to provide tolerance to electrolyte destabilization. The tolerance provided by the non-ionic surfactant will depend on the type of surfactant used or the mixture of surfactants used and the formulation of the paint. The test to ascertain the propensity for paint (sufficiently stabilized with non-ionic surfactant) to be stable under conditions of high ionic strength is best represented by adding an equivalent proportion of 10% Calcium Chloride solution to a paint. The paint will not harden if it is sufficiently stabilized against high ionic strength as shown in Example 2. In some cases, there is an intermediate position where the treated paint may have some stabilization but not complete stabilization. In these cases the paint may increase in viscosity but not harden instantly. An increase in viscosity is an indication that the treated paint may harden eventually given sufficient time.

In some embodiments, the non-ionic surfactants used to stabilize the water-based paint are ethoxylate non-ionic surfactants or mixtures of ethoxylate non-ionic surfactants. Suitable non-ionic surfactants include the Teric range of surfactants, such as Teric N40L, the Triton range of surfactants and the ABEX range of surfactants such as ABEX 2545. The longer the average length of the ethoxylate chain in the non-ionic surfactant, the more electrolyte tolerance is imparted by the surfactant. In some embodiments, the surfactant(s) used may have some non-ionic character and some charged character, either separately or in a single surfactant molecule with the use of such surfactants or combinations of surfactants, stabilization may occur when the non-ionic character is dominant. Exemplary paints stabilized by non-ionic surfactant include the US FreshAire range of paints and the UK Evermore range of paints.

The paint hardener composition contains an agent that increases the ionic strength of the paint. Many properties of ionic solutions depend on electrostatic interactions between ionic charges. A useful measure of ionic character is the ionic strength defined by:

$$I = 1 / 2 {\sum }_{i = 1}^{n} {m}_{i} {z}_{i}^{2}$$

where mᵢ is the molality of ion I (mol/kg H₂O), zᵢ is the charge number of that ion, and the summation is taken over all the different ions in a solution, multiplying the molality of each by the square of its charge. Hence the most highly charged ions will have the greatest influence on ionic strength. In a paint system, the solubilities of sparingly soluble salts and rates of other ionic reactions will all have a bearing on ionic strength.

In paints, the particles of pigment and latex held in suspension carry a substantial charge which in water is usually negative. This negatively charged barrier that prevents aggregation of the particles. The barrier can be removed by the addition of ionic salt to effectively neutralize or “screen” the surface charge of the particles in suspension. This removes the repulsive forces that keep the particles separate and allows for coagulation due to van der Waals forces.

In some embodiments, the agent comprises at least one aluminium compound, ferrous compound or ferric compound. Suitable compounds include aluminium sulphate, polyaluminium chloride, ferrous ammonium sulphate (alum), ferrous sulphate (FeSO₄), ferric sulphate (Fe₂(SO₄)₃) and ferric chloride (FeCl₃). In some embodiments, the agent is at least one aluminium compound, especially an aluminium compound selected from aluminium sulphate and polyaluminium chloride and mixtures thereof. In some embodiments, the agent comprises polyaluminium chloride (eg: poly AlCl₅) and aluminium sulphate (Al₂(SO₄)₃). In some embodiments the ratio of polyaluminium chloride and aluminium sulphate is in the range of 45:55 to 55:45, especially about 50:50.

Polyaluminium chloride (PAC) refers to a class of soluble aluminium compounds in which the aluminium chloride has been partly reacted with base. Polyaluminium chloride contains some highly cationic oligomers of aluminium and may be expressed by the formula:

Alₙ(OH)ₘCl₍₃ₙ₋ₘ₎

in which n and m are integers and n is greater than m. The basicity of the polyaluminium chloride is expressed as a percentage using the formula:

m/3n×100.

In some embodiments, the polyaluminium chloride is polyaluminium chloride (Basic). Polyaluminium chloride is available in a number of granulated or powder forms having different ranges of particulate size. In some embodiments, the polyaluminium chloride is of a fine grade having a small particulate size. The CAS Registry number of Polyaluminium chloride is 1327-41-9.

The aluminium sulphate may be anhydrous (Al₂(SO₄)₃. (CAS 10043-01-3) or may be in the form of a hydrate, such as Al₂(SO₄)₃.18H₂O (CAS 7784-31-8). In some embodiments, the aluminium sulphate is of fine grade having a small particulate size.

The composition also comprises at least one water soluble or water dispersible, natural or synthetic polymer. In some embodiments, the at least one polymer is a water soluble or water dispersible natural or synthetic polymer that is capable of interacting with the ethoxylate groups in a non-ionic surfactant, thereby reducing the electrolyte tolerance of the paint. In some embodiments, the at least one polymer is a synthetic homopolymer or copolymer such as a polyacrylic acid polymer or polyamide polymer. In some embodiments, the at least one polymer is a natural polymer or mixture of natural polymers, such as gelatine, Pea Protein Isolate, Agar-Agar and Soya Protein or mixtures thereof. In some embodiments, the at least one polymer is a natural polyamide polymer, such as gelatine, Pea Protein Isolate, Agar-Agar and Soya Protein or mixtures thereof, especially gelatine.

The ratio of agent that increases ionic strength to polymer will vary depending on the nature of the agent and the polymer and the hardness of the hardened paint product desired. The higher the amount of polymer, the more solid the hardened paint product will be. In some embodiments, the paint hardener composition comprises the agent that increases the ionic character of the paint and polymer compound in a ratio of 1:4 to 1:14. In some embodiments, the ratio of agent to polymer compound is 1:4 to 1:12, especially about 1:5 to 1:11.

In some embodiments, the paint hardener composition comprises 80% to 99.5% by weight of polymer and 0.5% to 20% by weight of the agent that increases the ionic strength of the paint, especially about 80% to 95% by weight of the polymer and about 5% to 20% by weight of the agent that increases the ionic strength of the paint. In some embodiments, the composition comprises 80% to 85% by weight of polymer, 7.5% to 10% by weight polyaluminium chloride and 7.5% to 10% by weight of aluminium sulphate. In a particular embodiment, the composition contains about 83% by weight gelatine, about 8.5% by weight polyaluminium chloride and about 8.5% aluminium sulphate. In other embodiments the composition comprises 90% to 95% by weight of polymer, 2.5% to 5% by weight polyaluminium chloride and 2.5% to 5% by weight aluminium sulphate. In a particular embodiment, the composition contains about 92% by weight gelatine, about 4% by weight polyaluminium chloride and about 4% by weight aluminium sulphate.

In another aspect of the invention there is provided a method of hardening paint with the composition described above. In particular, the method comprises adding the paint hardening composition to waste paint, mixing the resulting paint composition and allowing the paint to harden.

In some embodiments, the paint to be hardened is residual paint. As used herein the term “residual paint” refers to leftover paint that is surplus to needs after a domestic or commercial painting job is completed or paint that has been stored and/or is no longer required. The residual paint may be in a can or other type of container such as a plastic container.

In some embodiments, the amount of the paint hardening composition used is added to residual paint in an amount of 10 to 15% weight by volume of unhardened paint, especially about 11 to 14%, 11 to 13%, more especially about 12% weight by volume of unhardened paint.

Sometimes, it may be important to harden paint in the absence of an agent that increases the ionic character of the paint. For example, it may be required to limit the aluminium content of the hardened paint for environmental reasons. Advantageously in another aspect of the invention there is provided a method of hardening water-based paint comprising the steps of:
(i) providing waste water-based paint;
(ii) adding at least one water soluble or water dispersible, natural or synthetic polymer;
(iii) mixing the water-based paint and the polymer and allowing the resulting paint composition to harden.

In some embodiments, the waste water-based paint is residual paint. In some embodiments, the at least one polymer is a water soluble or water dispersible, natural or synthetic polymer that is capable of interacting with the ethoxylate groups in a non-ionic surfactant, thereby reducing the electrolyte tolerance of the paint. In some embodiments, the at least one polymer is a synthetic homopolymer or copolymer such as a polyacrylic acid polymer or polyamide polymer. In some embodiments, the at least one polymer is a mixture of polymers. In some embodiments, the at least one polymer is a natural polymer or a mixture of natural polymers. In some embodiments, the at least one polymer is a natural polyamide or a mixture of natural polyamides such as gelatine, Pea Protein Isolate, Agar-Agar and Soya Protein or mixtures thereof. In some embodiments, the polymer is gelatine.

The at least one polymer may be added to waste water-based paint in any amount that results in hardening of the paint to the desired level of hardness. The amount and type of polymer added affects the time taken for hardening to occur and the extent of hardening that occurs. In some embodiments, the amount of at least one polymer that is added to residual paint is in the range of 10% to 30% weight by volume, especially 10% to 25%, 10% to 15% weight by volume of unhardened paint, especially 10% to 15%.

The paint hardening composition or at least one polymer may be added to residual paint contained in a paint can or other container and the mixture mixed to disperse the paint hardening composition throughout the paint. In some embodiments mixing is continued to provide a substantially homogenous mixture of paint and paint hardening composition.

In the present invention, mixing may be achieved by any means. Conveniently, mixing may be performed manually, for example by stirring the paint and paint hardener composition or at least one polymer with a stirrer or swirling the paint and hardener composition. Alternatively, mechanical mixing may be used.

Paint “hardening” as used herein refers to an increase in the viscosity of the paint to provide a solid mass that has a consistency that can be moulded or has a particulate or crumbly consistency, for example, like sand. Alternatively hardening may be assessed relative to the extent of hardening of a water based paint known to harden when exposed to a composition containing 50% polyaluminium chloride and 50% aluminium sulphate. Different types of paint may have different hardening characteristics. For example, different types of paint may differ in the time required for hardening to occur or in the consistency of the hardened paint product.

Other factors may also affect the consistency of the hardened paint product and/or the time taken for hardening to occur. These factors may include, but are not limited to, environmental factors such as atmospheric humidity, component factors such as hygroscopicity and/or water content of the polymer, and physical factors such as mixing time.

When the composition of the invention is added to residual paint in a container, the paint coagulates and hardens. Upon addition of the paint hardening composition or at least one polymer, the paint solidifies usually within 20 seconds to 10 minutes. The time taken for hardening to occur may vary with the volume of paint being hardened. In some embodiments, particularly where at least one polymer is added in the absence of agent that increases the ionic character of the paint, hardening may take longer than 10 minutes. The time taken for hardening to occur is dependent on the type of paint, the volume of paint, the type of polymer and the amount of polymer used. The texture of hardened paint product ranges from a soft mass to a solid mass and may be granular or sand like or a single solid mass. The texture of the hardened paint product depends on the amount of polymer in the paint hardening composition or the amount of at least one polymer added and also the formulation of the paint. The hardened paint composition is then optionally stood for two hours to overnight in a well ventilated area to ensure evaporation of all residual water.

In yet another aspect of the invention there is provided a method of disposing of residual waste water-based paint comprising the steps of:
(i) hardening the residual water-based paint with a composition comprising:
   (a) an agent that increases the ionic strength of the paint; and
   (b) at least one water soluble or water dispersible, natural or synthetic polymer; and
(ii) disposing of the hardened residual paint.

In a further aspect of the invention, there is provided a method of disposing of residual waste water-based paint comprising the steps of:
(i) hardening residual waste water-based paint with at least one water soluble or water dispersible, natural or synthetic polymer; and
(ii) disposing of the hardened residual water-based paint.

In some embodiments of the above methods, the paint is stood, optionally in a well ventilated area, to allow evaporation of any residual water.

In some embodiments of these methods, the hardened paint is disposed of by burying in the ground. In other embodiments, the hardened paint is disposed of as rubbish at a dump or in general household waste collection. In some embodiments, particularly those in which the paint hardening composition comprises an agent that increases the ionic strength of the paint and at least one water soluble or water dispersible, natural of synthetic polymer, the buried hardened paint has significantly reduced leaching into the soil compared to burying unhardened paint or paint that has been hardened with other types of paint hardeners. In particular, this hardened paint has significantly reduced ability to or does not leach water or paint upon exposure to water in household waste, rubbish dumps or in the soil than paint hardened with other types of paint hardeners.

In some embodiments, the hardened paint is removed from the container before disposal. In some embodiments, the paint containers, after removal of the hardened paint, are recycled.

In order that the nature of the present invention be more clearly understood and put into practical effect, specific embodiments will now be described by way of the following non-limiting examples.

A person skilled in the art will appreciate that many embodiments and variations can be made without departing from the ambit of the present invention.

### EXAMPLES

### Comparative Example 1

### Hardening of Paint with High Levels of Non-Ionic Surfactant with Known Waste Paint Hardener

A known paint hardener containing 50% aluminium sulphate and 50% polyaluminium chloride was used to assess the paint hardening in paints containing high levels of non-ionic surfactant, US FreshAire Eggshell, US FreshAire Flat, US FreshAire Semigloss and UK Evermore Eggshell. The amount of hardening was visually assessed. The results are shown in Table 1.

TABLE 1

| | 5% paint hardener in | 25% paint hardener in |
|---|---|---|
| | wet paint (comments | wet paint (comments |
| Paint Sample | on adding hardener) | on adding hardener) |
| US FreshAire Eggshell | No hardening, slightly | No hardening, more |
| | viscous | viscous |
| US FreshAire Flat | No hardening, slightly | No hardening, more |
| | viscous | viscous |
| US FreshAire Eggshell | No hardening, slightly | No hardening, more |
| | viscous | viscous |
| UK Evermore Eggshell | No hardening, slightly | No hardening, more |
| | viscous | viscous |

The results demonstrate that the known paint hardener does not effectively harden paints containing high amounts of non-ionic surfactant.

### Comparative Example 2

### Inhibition of Hardening of Paint by Non-Ionic Surfactant

A known paint hardener containing 50% aluminium sulphate and 50% polyaluminium chloride (5 gm) was used to assess the paint hardening in latex paint (100 g). Varying amounts of non-ionic surfactant, Teric N40L, were added to the wet latex paint. The amount of hardening was visually assessed. The results are shown in Table 2.

TABLE 2

| | 0% | 0.25% | 0.5% | 1.0% | 2.5% | 5.0% | 11.0% |
|---|---|---|---|---|---|---|---|
| | Teric | Teric | Teric | Teric | Teric | Teric | Teric |
| Latex Paint | N40L | N40L | N40L | N40L | N40L | N40L | N40L |
| proprietary | H | H | H | V | No | No | No |
| anionic | | | | | | | |
| stabilised | | | | | | | |
| styrene/ | | | | | | | |
| acrylic latex | | | | | | | |
| ECO 505AP | — | H | — | H | V | V | V |
| (commercially | | | | | | | |
| available | | | | | | | |
| styrene/acrylic | | | | | | | |
| latex) | | | | | | | |

H = Hardens
V = Becomes viscous
No = No hardening

Increasing amounts of long-chain ethoxylate non-ionic surfactants prevent or hinder the hardening mechanism of known paint hardeners. Not wishing to be bound by theory, it is thought that the non-ionic surfactant prevents the increase of ionic character required for coagulation of the latex particles and hardening of the paint.

### Example 1

A sample of low VOC FreshAire Eggshell paint containing high levels of non-ionic surfactant were treated with gelatine alone or a composition comprising varying amounts of gelatine and an agent comprising 50% polyaluminium chloride and 50% aluminium sulphate. The extent of hardening was assessed visually immediately upon addition of the composition or gelatine and was also assessed relative to the extent of hardening observed in paint known to harden immediately upon addition of a paint hardener containing 50% polyaluminium chloride and 50% aluminium sulphate. The results are shown in Table 3.

TABLE 3

| Composition | US FreshAire low VOC paint |
|---|---|
| (% added to wet paint) | Eggshell hardening |
| 10% gelatine | No hardening |
| 20% gelatine | No hardening |
| 5% gelatine | No hardening |
| 0.5% polyaluminium chloride | |
| 0.5% aluminium sulphate | |
| 10% gelatine | No hardening |
| 0.5% polyaluminium chloride | |
| 0.5% aluminium sulphate | |
| 5% gelatine | Viscous |
| 1% polyaluminium chloride | |
| 1% aluminium sulphate | |
| 6% gelatine | Thick paste |
| 1% polyaluminium chloride | |
| 1% aluminium sulphate | |
| 8% gelatine | Hardens to soft mass |
| 1% polyaluminium chloride | |
| 1% aluminium sulphate | |
| 9% gelatine | Hardens to slightly |
| 1% polyaluminium chloride | harder mass |
| 1% aluminium sulphate | |
| 10% gelatine | Hardens to a hard mass, |
| 1% polyaluminium chloride | easy to remove from |
| 1% aluminium sulphate | container |

These results demonstrate that the addition of the polyamide polymer, gelatine, to polyaluminium chloride and aluminium sulfate results in hardening of the paint.

### Example 2

### Testing the Electrolyte Tolerance of a Paint

A 10% Calcium Chloride solution was added to an equivalent volume of US FreshAire Flat without inducing coagulation. However adding a 10% Calcium Chloride solution to Dulux Wash & Wear Advanced Low Sheen White (which hardens with the known paint hardener containing 50% aluminium sulphate and 50% polyaluminium chloride) resulted in immediate coagulation as shown in Table 4.

TABLE 4

| | Dulux Wash & Wear 101 | |
|---|---|---|
| | Advanced Low Sheen | US FreshAire |
| Test Reference | White | Flat White |
| Add 10% Calcium Chloride | Coagulates instantly | No change |
| Solution in water | | |

### Example 3

### Source of Gelatine

Different gelatine products from different sources were used in combination with Polyaluminium chloride and aluminium sulfate 1:1 mixture referred to as “Part B”. The hardener composition used included Part B: gelatine in a ratio of 2:10% weight by volume of paint. The composition was added to 100 mL of paint, either Dulux Wash & Wear 101 Advanced Low Sheen White or US FreshAire Eggshell White and the mixture stirred with a spatula. The results are shown in Table 5.

TABLE 5

| | Dulux Wash & Wear 101 | |
|---|---|---|
| | Advanced Low Sheen | US FreshAire |
| Gelatine | White | Eggshell White |
| Supermarket (Ward's) | Hardens | Hardens |
| Australia (Gelita, Tech40) | Hardens | Hardens |
| China (IMCD) | Hardens | Hardens |

### Example 4

Samples of US FreshAire Ceiling Flat paint (US Flat) or US FreshAire SemiGloss White (US Semi Gloss) were treated with gelatine alone or with a composition of polyaluminium chloride and aluminium sulphate 1:1 (Part B). The gelatine used was Tech 40 grade or IMCD sourced from China. Different ratios of Part B to gelatine were assessed and different amounts of gelatine alone were assessed. The gelatine or gelatine/Part B composition was added to 100 mL of paint (US Flat) or 50 mL of paint (US Semi Gloss) and the mixture stirred. The time taken for the paint to harden and mould into a specific shape was recorded. The results are shown in Table 6.

TABLE 6

| | | US Flat | US Semi Gloss |
|---|---|---|---|
| Formula reference | Ratio % | (time, min) | (time, min) |
| Part B:Tech40 | 2:10 | 4-5 | 2.5 |
| Part B:Tech40 | 1:11 | — | 2 |
| Tech40 | 10 | 8-9 | — |
| Tech40 | 12 | — | 3-4 |
| Tech40 | 14 | 2-3 | — |
| Part B:IMCD | 2:10 | 6-7 | 9-10 (100 ml) |
| | | | 3-4 (50 ml) |
| Part B:IMCD | 1:11 | — | 2 |
| IMCD | 10 | 6-7 | 2.5 |
| IMCD | 12 | 3-4 | 1.5 |
| IMCD | 14 | 1-2 | — |

(— not determined)

### Example 5

Hardening of different paints was assessed with a composition comprising Part B: Tech 40 gelatine 2:10%, Part B: IMCD gelatine 2:10%, Part B: IMCD gelatine 1:11% and 12% IMCD gelatine alone. Each percentage being a percentage weight by volume of unhardened paint. The volume of unhardened paint used was 50 mL. The mixtures of paint and hardener were mixed and the time taken for the paint to harden and mould to a specific shape was recorded. The results are shown in Table 7.

TABLE 7

| | Part B: | | | |
|---|---|---|---|---|
| | Tech40 | Part B: | Part B: | |
| | (2:10) | IMCD | IMCD | IMCD |
| | % control | (2:10) | (1:11) | (12) |
| Paint reference | (min) | % (min) | % (min) | % (min) |
| Dulux Wash & Wear | 20 sec | 20 sec | 40 sec | 2.5 |
| 101 Advanced Low | | | | |
| Sheen White | | | | |
| Dulux New Ceiling | 6-7 | 40 sec | 1.5 | 3.5 |
| White | | | | |
| Dulux Old Ceiling | 2 | 2 | 1.5 | 4 |
| White | | | | |
| Dulux Aquanamel | 2 | 2 | 3 | 3 |
| Semi Gloss White | | | | |
| Dulux Weather- | 2 | 3 | 4 | 5 |
| shield Low | | | | |
| Sheen White | | | | |
| Wash & Wear 101 | 1 | 0 | 1.5 sec | 2.5 |
| Advanced Semi | | | | |
| Gloss White | | | | |
| US FreshAire Semi | 5 | 7 | 4 | 3.5 |
| Gloss White | | | | |
| US FreshAire | 5 | 4.5 | 2.5 | 3.5 |
| Eggshell | | | | |
| US FreshAire | 4 | 4 | 2 | 3.5 |
| Ceiling Flat | | | | |
| UK Evermore | 3.5 | 3.5 | 3 | 3 |
| Eggshell | | | | |

### Example 6

Different polymers were assessed for hardening of paint. The paint used was US FreshAire Ceiling Flat Paint (50 mL). Different amounts (weight by volume) of selected hardeners were added to the paint and the hardening of the paint observed. Qualitative assessment of leaching was also made by adding 10 gm of hardened paint to 100 mL of water and in a glass jar. The clarity of the water was then noted after 1 day. The results are shown in Table 8.

TABLE 8

| | Gelatine IMCD | | | | | | | | |
|---|---|---|---|---|---|---|---|---|---|
| | | | | | Du. | | | | |
| | | | | Du. | WPH:IMCD | | | Pea Protein | |
| | | | | WPH:IMCD | 1:11(pre- | Gelatine Tech40 | | Isolate | |
| Reference | 12% | 15% | 20% | 1:11(control) | mixed) | 15% | 20% | 12% | 20% |
| time taken to | 9 | 4 | 1.7 | 4 | 4 | 3 | 1.3 | >10 | 0.5 |
| harden (min) | | | | | | | | | |
| other | harden | harden | harden | hardens ok. | hardens ok. | hardens | harden | Hardens, but | harden |
| comments | ok. easy | ok. easy | instantly. | easy to | easy to | ok. easy | instantly. | still very | instantly. |
| | to work | to work | Very easy | work with | work with | to work | Very easy | sticky and | difficult to |
| | with, | with. | to work | | | with | to work | pasty after | work with. |
| | takes | | with | | | | with | 10 min | |
| | time | | | | | | | | |
| Qualitative | cloudy at | cloudy at | Less | clear all | clear all | cloudy at | cloudy at | cloudy all | cloudy all |
| leach | bottom | bottom | cloudy at | the way | the way | bottom | bottom | the way. | the way. |
| analysis | | | bottom | | | | | more @ | more @ |
| ref: TN7724 | | | than above | | | | | bottom | bottom |

| | Agar-Agar | | Soya Protein | | Milk Powder | |
|---|---|---|---|---|---|---|
| Reference | 12% | 20% | 12% | 20% | 12% | 20% |
| time taken to | >10 | 0.5 | thickens in | thickens in | does | does |
| harden (min) | | | seconds but still | seconds but still | not | not |
| | | | very sticky and | very sticky and | harden | harden |
| | | | pasty after 10 min | pasty after 10 min | | |
| other | Still | harden | thickens in | thickens in | Still | Still |
| comments | porable | instantly. | seconds, but no | seconds, but no | porable | porable |
| | after | Very easy | signs of | signs of | after | after |
| | 10 min | to work | hardening. very | hardening. very | 10 min | 10 min |
| | | with | sticky and pasty | sticky and pasty | | |
| | | | after 10 min | after 10 min | | |
| Qualitative | very cloudy | very cloudy | cloudy all | cloudy all | cloudy all | cloudy all |
| leach | all the way | all the way | the way | the way | the way | the way |
| analysis | | | | | | |
| ref: TN7724 | | | | | | |

### Example 7

Agar-Agar alone or in combination with 1:1 polyaluminium chloride:aluminium sulfate (Part B) was assessed for hardening action on US FreshAire Flat White paint. The hardeners were added to 100 mL paint samples, the mixture stirred and hardening assessed. The results are shown in Table 9.

TABLE 9
(US Flat White)

| Part B:Agar-Agar | |
|---|---|
| Powder (%) | Observations |
| 2:10 | Takes time to harden. Cannot mould in to a shape too |
| | soft. Hardens over night |
| 0:14 | Hardens faster than above. Can mould in to a shape. |
| | Takes more time in comparison to gelatine |
| 0:20 | Harden instantly. can mould in to a shape |

1. A composition for hardening water-based paint comprising:
i) an agent that increases the ionic strength of the water-based paint to be hardened; and
ii) at least one water soluble or water dispersible, natural or synthetic polymer.

2. The composition according to claim 1 wherein the agent comprises at least one aluminium compound, ferrous compound, ferric compound, or mixtures thereof.

3. The composition according to claim 1 wherein the agent comprises at least one aluminium compound.

4. The composition according to claim 3 wherein the at least one aluminium compound is selected from the group consisting of polyaluminium chloride, aluminium sulphate, and mixtures thereof.

5. The composition according to claim 1 wherein the at least one water soluble or water dispersible, natural or synthetic polymer is a water soluble or water dispersible, natural polymer.

6. The composition according to claim 5 wherein the at least one water soluble or water dispersible, natural polymer is selected from the group consisting of gelatine, Pea Protein Isolate, Agar-Agar, Soy Protein, and mixtures thereof.

7. The composition according to claim 6 wherein the at least one water soluble or water dispersible, natural polymer is gelatine.

8. The composition according to claim 3 wherein the agent comprises about 50% polyaluminium chloride and about 50% aluminium sulphate.

9. The composition according to claim 1 wherein the composition comprises the agent and the at least one water soluble or water dispersible, natural or synthetic polymer in a ratio of 1:4 to 1:14.

10. A method of hardening water-based paint comprising the steps of:
(i) providing waste water-based paint;
(ii) adding a composition comprising:
(a) an agent that increases the ionic strength of the waste water-based paint; and
(b) at least one water soluble or water dispersible, natural or synthetic polymer; and
(iii) mixing the waste water-based paint and the composition and allowing the resulting paint composition to harden.

11. A method of hardening water-based paint comprising the steps of:
(i) providing waste water-based paint;
(ii) adding at least one water soluble, water dispersible, natural or synthetic polymer;
(iii) mixing the waste water-based paint and the at least one water soluble, water dispersible, natural or synthetic polymer and allowing the resulting paint composition to harden.

12. A method of disposing of residual waste water-based paint comprising the steps of:
(i) hardening residual water-based paint with a composition comprising:
(a) an agent that increases the ionic strength of the waste water-based paint; and
(b) at least one water soluble or water dispersible, natural or synthetic polymer; and
(ii) disposing of the hardened residual paint.

13. A method of disposing of residual waste water-based paint comprising of the steps of:
(i) hardening residual water-based paint with at least one water soluble, water dispersible, natural or synthetic polymer; and
(ii) disposing of the hardened residual paint.

14. A method according to claim 10 wherein the at least one water soluble or water dispersible, natural or synthetic polymer is selected from the group consisting of gelatine, Pea Protein Isolate, Agar-Agar and Soy Protein, and mixtures thereof.

15. A method according to claim 10 wherein the agent comprises at least one aluminium compound selected from the group consisting of polyaluminium chloride, aluminium sulphate, and mixtures thereof.

16. A method according to claim 11 wherein the at least one water soluble, water dispersible, natural or synthetic polymer is selected from the group consisting of gelatine, Pea Protein Isolate, Agar-Agar, Soy Protein, and mixtures thereof.

17. A method according to claim 12 wherein the at least one water soluble or water dispersible, natural or synthetic polymer is selected from the group consisting of gelatine, Pea Protein Isolate, Agar-Agar, Soy Protein, and mixtures thereof.

18. A method according to claim 13 wherein the at least one water soluble, water dispersible, natural or synthetic polymer is selected from the group consisting of gelatine, Pea Protein Isolate, Agar-Agar, Soy Protein, and mixtures thereof.

19. A method according to claim 12 wherein the agent comprises at least one aluminium compound selected from the group consisting of polyaluminium chloride, aluminium sulphate, and mixtures thereof.
